(19) United States
(12) Patent Application Publication
(10) Pub. No.: US 2004/0020091 A1
(43) Pub. Date: Feb. 5, 2004

(54) Product identifier system

(76) Inventors: Terry J. Johnson, Chicago, IL (US); Travis O. Johnson, Chicago, IL (US)

Correspondence Address: VEDDER PRICE KAUFMAN & KAMMHOLZ, 222 N. LASALLE STREET, CHICAGO, IL, 60601, US

(21) Appl. No.: 10/210,759

(22) Filed: Aug. 1, 2002

(51) Int. Cl. G09F 3/18

(52) U.S. Cl. 40/661.03

(57) ABSTRACT

A product identifier system for identifying each of a plurality of groups of products arrayed on shelves, wherein the contents of each of the product groups differ but the groups have like product containers and similar labels. The product identifier system includes a product dividing apparatus for dividing the plurality of products that includes a base having a base clip contactingly engaging the shelf ledge, a base arm having at least one tab and a connector having an at least one aperture, wherein the connector is coupled to the base. Moreover, the product dividing apparatus includes a billboard having at least one aperture. The billboard is held in place by the contacting engagement of the base and the connector, wherein the billboard extends upward therefrom to divide said plurality of products, wherein the billboard is further rotationally adjustable relative to the base with respect to the shelf.

### FIELD OF THE INVENTION

The present invention relates generally to an apparatus and system for dividing a plurality of products disposed on at least one shelf.

### BACKGROUND OF THE INVENTION

In modem retail establishments, with the increase in the number of available products on the market, available shelf space has become a premium asset. Often times, commercial items must be spaced extremely close together on a particular shelf to accommodate the various varieties and different manufacturing brands of a particular item. Furthermore, some manufacturers produce a large number of different varieties of a single product line having similar containers and similar logos. Therefore, it may be difficult for a consumer to immediately distinguish between various varieties of a single brand of like products.

For example, in a grocery store a shopper may encounter numerous brands of canned soups produced by numerous manufacturers. Each of these manufacturers may produce a large number of different varieties of canned soup with the outside labels of the various cans of soup being virtually identical with the exception of a single line of text or an image. Furthermore, the large number of available selections between different varieties within a single brand may encompass numerous shelves, extending horizontally not only lengthwise up and down a particular aisle, but also encompassing all shelves in a vertically extending section—a veritable wall of cans of soup. Thus, for a typical consumer, it may be a time-consuming task to find and select a particular variety of a particular brand of soup, or any other product similarly positioned in large quantities in a concentrated area within a retail store, such as canned vegetables, baby food, salad dressings, etc. The same holds true for other items in other retail outlets where the consumer does not have time to search for a given product or products.

In an attempt to overcome customer confusion regarding the similar labels on various product varieties within a single brand, some manufacturers align numerous (e.g. six) of the same variety in sets along a row across the front of the shelves so that the consumer may more readily be able to detect a particular variety within a brand (e.g. chicken noodle soup). As alluded to above, this technique has drawbacks due to the limited amount of available shelf space and the copy on the container stays the same size no matter how many containers are put side-by-side.

Accordingly, there exists a need for a way for improving a consumer's ability to quickly and effectively locate a particular brand or brand variety while minimizing the need for extra shelf space to accommodate placement of numerous amounts of the same product in a side-by-side relationship.

### SUMMARY OF THE INVENTION

In accordance with one aspect of the present invention, there is provided a product identifier system for identifying each of a plurality of groups of products arrayed on shelves wherein the contents of each of the product groups differ but the groups have like product containers and similar labels. The product identifier system includes a plurality of signs or billboards, there being at least one such billboard for each of the groups of products, wherein each billboard bears indicia identifying the contents of a separate one of the groups of products. First and second of the billboards are horizontally disposed in a spaced apart relationship with one of the groups of products being disposed therebetween. A second group of products is separated from the first group of products by one of the first and second billboards. One of the first and second billboards has indicia identifying the contents of the first group of products and the other of the billboards has indicia identifying the contents of the second group of products.

In accordance with another aspect of the invention, the billboards are secured to shelving by a holder so that each billboard extends transversely of the shelving with a portion thereof extending out toward the aisle so that the indicia is visible to a shopper.

In the presently preferred form, the holder includes a base having a base clip that contactingly engages the price rail (i.e. shelf ledge), a base arm having at least one tab, a connector having an aperture, the connector being coupleable to the base, and a billboard having at least one aperture. The billboard extends upwardly from the front of the shelf and is held in place by the contacting engagement of the base and the connector. The billboard extends upward and back into the shelf to divide the various varieties and different brands of products. In one embodiment, the billboard is rotationally adjustable about a lower aperture therein.

It has been found that use of the system of the present invention allows for reduction of the number of identical varieties of product within a common brand to be placed side-by-side and therefore reducing the shelf space required for the product while reducing the labor to maintain the inventory and still increase the ability of the consumer to find the desired variety which therefore increases sales.

### BRIEF DESCRIPTION OF THE DRAWINGS

The present invention is illustrated herein, wherein:

FIG. 1 illustrates a product identifier system in accordance with one embodiment of the present invention;

FIG. 2a illustrates a perspective view of a front side of a base, in accordance with one embodiment of the present invention;

FIG. 2b illustrates a perspective view of a back side of the base of FIG. 2a;

FIG. 3 illustrates a perspective view of a connector, in accordance with one embodiment of the present invention;

FIG. 4 illustrates a side view of a billboard, in accordance with one embodiment of the present invention; and

FIG. 5 illustrates, in perspective view, a product dividing system, in accordance with one embodiment of the present invention.

### DETAILED DESCRIPTION OF THE DRAWINGS

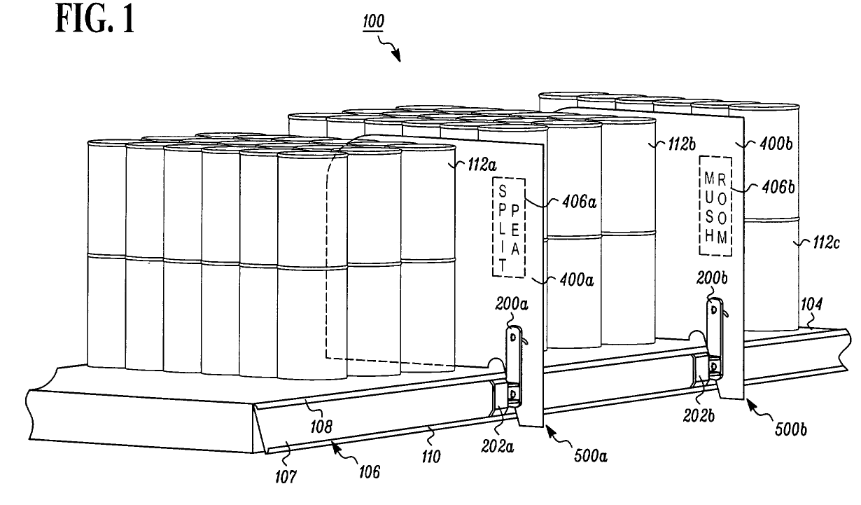

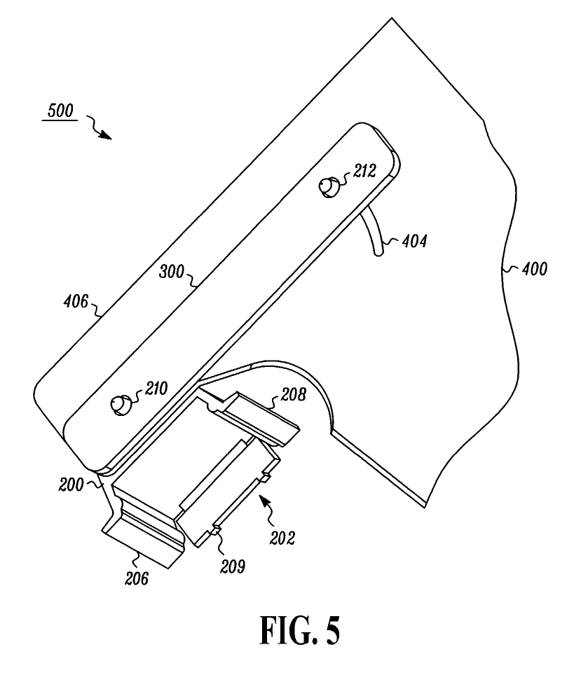

FIG. 1 illustrates a product identifier system 100 for identifying each of a plurality of groups of products, 112a, 112b and 112c, are arrayed on a shelf 104, in accordance with one embodiment of the present invention. The system 100 includes a first billboard divider assembly 500a and a second assembly 500b, as discussed below with reference to FIG. 5, which extend transversely about the shelf 104. The shelf 104 has a front ledge 106 contoured by a center channel 107 with a curved top lip 108 and a curved bottom lip 110. FIG. 1 further provides the plurality of groups of products, 112a, 112b and 112c have differing contents, but have like product containers, illustrated herein as cans, and similar labels, not expressly illustrated.

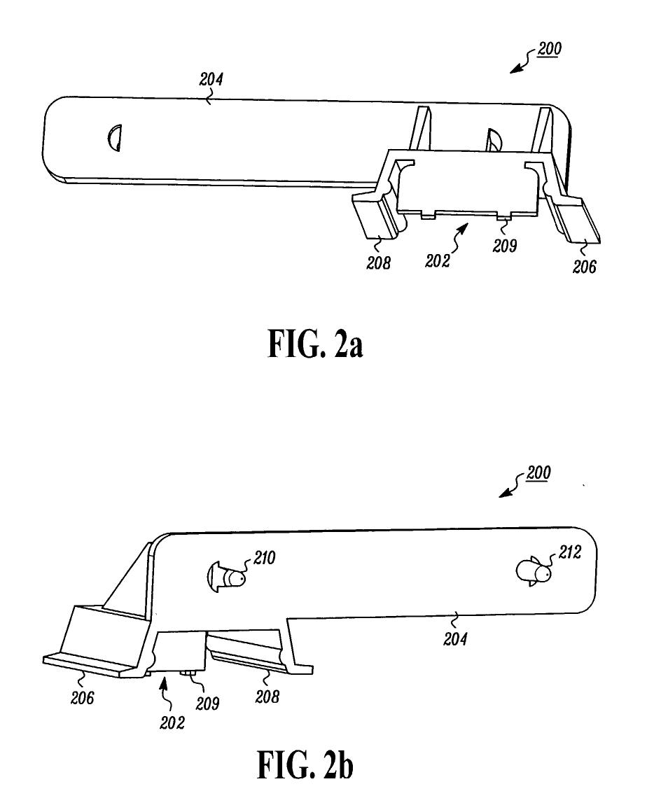

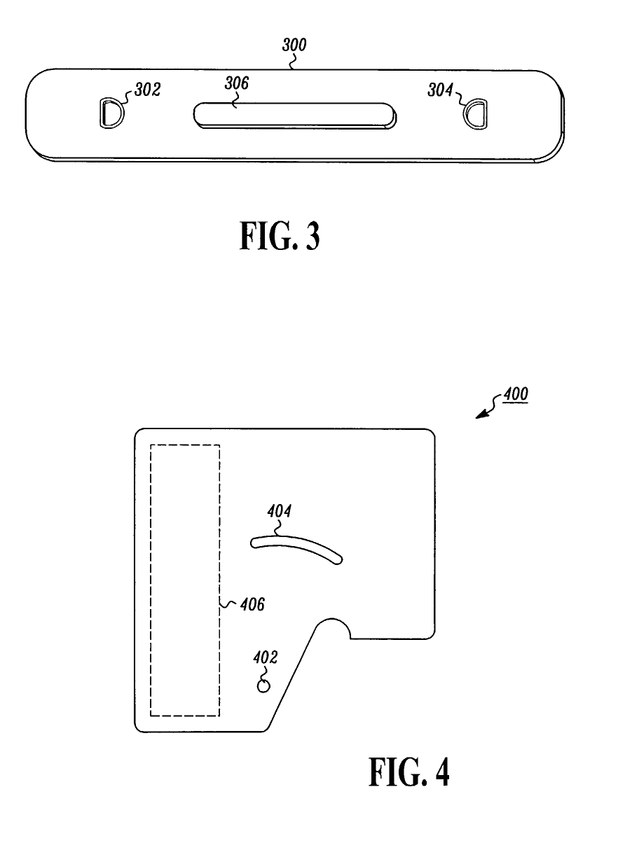

As discussed below with reference to FIGS. 2-5, the billboard dividers 400a and 400b include a base 200a, 200b and an attached base clip 202a, 202b, which engage the center channel 107, also known as a price rail, of the shelf 104. More specifically, the base clip 202a, 202b engages of the front ledge 106 by engaging the top lip 108 and the bottom lip 110. Each billboard divider 400a, 400b includes a base 200a, 200b, which are held in place by the disposition of the connectors 300a, 300b relative to a base (not visible in FIG. 1), as discussed further with reference to FIG. 3.

Within the product identifier system 100, the billboard dividers assembly 500a and 500b allows for the billboard dividers 400a, 400b, to be in contacting engagement with the shelf 104 regardless of the angle of the c-channel 107 on the front ledge 106. Some shelves provide a front ledge 106 having a vertically extending c-channel 107 where the top lip 108 is disposed directly over the bottom lip 110, whereas other shelves provide a front ledge having a pitched front ledge, such as illustrated in FIG. 1, where the bottom lip 110 extends further out from the shelf 104 than the top lip 108. Typically, the c-channel 107 is used to hold various items used by the retail establishment relating to the items for sale, such as a price tag, eliminating the retail establishment from having to individually price each product, but rather allowing them to rely on a universal product code (UPC) label for affixing the products'cost at the time of sale. As the front ledges of different types of shelves have different pitches, the billboard divider assembly 500a, 500b allows for the billboards 400a, 400b to maintain a flush contact with the shelf 104 by allowing the billboards to be rotationally displaceable about a lower aperture (404 of FIG. 4) through the adjustment of the position of a second tab (212 of FIG. 2b) within an arcuate-shaped upper channel allowing the copy area 406a, 406b to be properly orientated for reading.

The system 100 provides for the identification of a plurality of groups of products 112a, 112b and 112c arrayed on the at least one shelf 104 through the billboards 400a, 400b having a copy area 406ba, 406b bearing an indicia identifying the contents of only one of the groups of products, such as 112a, 112b, or 112c. As illustrated in FIG. 1, the two billboards are disposed in a horizontally disposed space apart relationship having a group of products 112b disposed between and bordered by the billboards 400a, 400b. FIG. 1 further illustrates another group of products, such as 112a or 112c, which are separated from group of products 112b by the billboard divider assembly 500a, 500b. Also illustrated in FIG. 1, the first billboard 400a bears an indicia of “split pea” in the copy area 406a to represent the group products 112a contain split pea soup and the second billboard 400b bears an indicia of “mushroom” in the copy area 406b to represent the group of products 112b contain mushroom soup, wherein the indicia are illustration purposes only and other suitable indicia may be utilized to distinguish the groups of products, such as 112a, 112b and 112c.

FIGS. 2a and 2b illustrate the base 200 in accordance with one embodiment, including the base clip 202 and a base arm 204. The base clip 202 has a lower base clip flange 206 and an upper base clip flange 208. In the preferred embodiment, the base clip 202 further contains a locking flange 209 disposed between the lower base clip flange 206 and the upper base clip flange 208, for locking the displacement of the flanges 206 and 208 when the base clip 202 is engaged within the shelf rail 107. The base arm 204 has a first tab 210 and a second tab 212 disposed at opposing ends of the base arm 204.

As further illustrated in FIG. 2b, the tab portions 210 and 212 outwardly project from the base arm 204. Moreover, in one embodiment of the present invention, the tab portions 210, 212 include a chamfered tip having a notched cylinder for improved clasping, as discussed below. FIGS. 2a and 2b also illustrate the extension of the base clip 202 from the base arm 204. The base clip 202 is disposed below the base arm 204 and in one embodiment, is in offset alignment with the base arm 204.

FIG. 3 illustrates a connector 300, in accordance with one embodiment of the present invention. The connector 300 has approximately the same dimensions as the base arm 204 and includes a first aperture 302 and a second aperture 304 disposed at opposing ends of the connector 300. As discussed in greater detail below, the apertures 302, 304 of the connector are disposed apart by a distance equivalent to the distance between the tab portions 210 and 212; wherein the apertures 302, 304 may be positionally aligned with respect to the tab portions 210, 212 of the base arm 204 for attachment and securement thereon. Connector 300 will accept and secure two billboard dividers 400 for plan-o-gram flexibility. The connector also has a built-in spacer 306 that can be used for a single or thinner billboard. The connector 300 is turned inward so the 306 spacer is in between the base 210 and connector 302 and accordingly base 212 and connector 304.

FIG. 4 illustrates the billboard 400, in accordance with one embodiment of the present invention, having a marginal thickness. The billboard 400 includes a lower aperture 402 and an upper channel 404. Furthermore, the billboard includes the display area 406 for the placement of various types of advertising, product indicia, or any other distinguishing information for a plurality of products compactly disposed on a shelf 104.

As discussed below with reference to FIG. 5, the lower aperture 402 and the upper channel 404 are disposed from each other a distance consistent with the distance between the first tab portion 210 and the second tab portion 212 of the base and the distance between the first aperture 302 and the second aperture 304 of the connector 300.

In accordance with the preferred embodiment of the present invention, FIG. 5 illustrates the product billboard divider assembly 500 of the product identifying system fully assembled. The billboard divider assembly 500 includes the billboard 400 disposed between the base 200 and the connector 300. The first tab 210 portion extends through the lower aperture 402 of the billboard and through the first aperture 302 of the connector, wherein the first tab portion 210 is snap-fitted into place through contacting engagement with the connector 300 based on the thickness of the connector 300 and the billboard 400.

Furthermore, the billboard divider assembly 500 provides the benefit of being rotationally displaceable by the adjustment of the position of the second tab 212 in contacting engagement with the second aperture 304 within the upper channel 304. The billboard may be rotationally adjustable relative to the base 200, whereupon when the base 200 is in contacting engagement with a shelf, the billboard may be adjusted to properly extend vertically. Similar to the contacting engagement of the first tab portion 210, the second tab portion 212 contactingly engages the connector 300 through the second aperture 304 and the upper channel 404 and is snap-fitted into a secured position based on the thickness of the billboard 400 and the connector 300.

The billboard 400 of the product divider assembly 500 also provides the outwardly extending copy area 406, in relation to the base clip 202 that engages the shelf ledge 106. This copy area 406 may be used for displaying different types of display information for the benefit of a shopper or for making the searching process for finding a specific item amongst like labels items easier. In one embodiment of the present invention, the copy area contains labels directed to the specific brand varieties disposed between adjacent dividers on a plurality of shelves extending both heightwise and lengthwise within a shopping aisle.

FIG. 1 illustrates the billboard divider 400 capable of being fixably attachable to a shelf 104 for upwardly extending therefrom using a securing means including the base 200 and the connector 300. As recognized by one having ordinary skill in the art, other securing means for securing the billboard 400 in relation to the shelf 104 may be employed, as the illustrated example of FIG. 1, is not herein so limiting. For example, the billboard may be attached to the base using an adhesive means instead of being snap-fit into position using the connector. The billboard may be engaged with the base using any other available fastening means, such as, but not limited to at least one nail, at least one screw, at least one bolt, Velcro®, magnetic attraction, a clamp, a tongue and groove attachment. Wherein the base 200 attaches to a front ledge of a shelf.

As such, the product identifier system 100 allows a consumer to quickly identify different varieties of a common brand of a particular product. Once again using the example of canned soup, the consumer may be able to distinguish between the numerous varieties of canned soup, where all of the varieties are manufactured by the same manufacturer and contain similar labels. In the preferred embodiment, the billboard divider 400 extends back into the shelf 104, also providing a physical divider between the products, such as 112a, 112b and 112c. The identifier system 100 also provides for the dividers, such as 400a and 400b, to be attached to the front ledge 106 of the shelf at various locations, whereupon the amount of defined shelf space for a particular variety may be adjusted. For example, proportional shelf space relative to a product's demand may be created wherein a more popular variety has a large defined shelf space for more products and a products in less demand may be stocked in smaller quantities, but still be readily identified on a crowded shelf of like-labeled products.

It should be understood the present invention includes implementations of other variations and modifications of the invention and its various aspects as may be readily apparent to those of ordinary skill in the art, and that the invention is not limited by the specific embodiments described herein. It is therefore contemplated to cover by the present invention, any and all modifications, variations, or equivalents to fall within the spirit and scope of the basic underlying principles disclosed and claimed herein.

What is claimed is:

1. A product identifier system for identifying each of a plurality of groups of products arrayed on shelves wherein the contents of each of the product groups differ but said groups have like product containers and similar labels, said system including a product dividing apparatus for dividing the plurality of products arrayed on shelves, wherein the shelves each have a shelf ledge, the product dividing apparatus comprising a base, a connector coupled to said base, and a billboard upwardly extending from said base and said connector, wherein said base attaches to said shelf ledge and the billboard upwardly extends therefrom to divide said plurality of products.

2. The product identifier system of claim 1 wherein said product dividing apparatus further includes a base clip contactingly engaging said shelf ledge and a base arm having a first tab and a second tab.

3. The product identifier system of claim 2 wherein said base clip of said product dividing apparatus includes an upper base clip flange and a lower base clip flange for engaging a c-channel within said shelf ledge.

4. The product identifier system of claim 2 wherein said at least one connector of said product dividing apparatus includes a first aperture and a second aperture.

5. The product identifier system of claim 4 wherein said at least one billboard further comprises a lower aperture and an upper channel having an arcuate shape.

6. The product identifier system of claim 5 wherein said billboard is secured between said connector and said base through the engagement of said first tab into said first aperture through said lower aperture and the engagement of said second tab into said second aperture through said upper channel.

7. The product identifier system of claim 6 wherein said billboard is rotationally displaceable about said lower aperture through the adjustment of said second tab engagement with said second aperture within the upper channel.

8. The product identifier system of claim 1 wherein said at least one billboard extends outwardly from said shelf providing a display area.

9. The product identifier system of claim 8 wherein said display area contains indicia identifying contents of products on said shelf.

10. The product identifier system of claim 8 wherein said wherein said display area contains advertising material relating to said products.

11. A product identifier system for identifying each of a plurality of groups of products arrayed on shelves wherein the contents of each of the product groups differ but said groups have like product containers and similar labels, said system including a product dividing apparatus for dividing the plurality of products arrayed on shelves, wherein the shelves each have a shelf ledge, the product dividing apparatus comprising a billboard and a securing means for securing the billboard to said shelf ledge, wherein the billboard upwardly extends from said securing means and from said shelf ledge to divide said plurality of products and the billboard is rotationally displaceable within the securing means.

12. The product identifier system of claim 11 wherein said securing means comprises a base having a base clip for contactingly engaging said shelf ledge and a connector coupled to said base, wherein said base clip includes an upper base clip flange and a lower base clip flange for engaging a c-channel within said shelf ledge.

13. The product identifier system of claim 12 wherein said base further includes a base arm having a first tab and a second tab, said connector includes a first aperture and a second aperture, and said billboard includes a lower aperture and an upper channel having an arcuate shape.

14. The product identifier system of claim 13 wherein said billboard is secured between said connector and said base through the engagement of said first tab into said first aperture through said lower aperture and the engagement of said second tab into said second aperture through said upper channel.

15. The product identifier system of claim 14 wherein said billboard is rotationally displaceable about said lower aperture through the adjustment of said second tab engagement with said second aperture within the upper channel.

16. The product identifier system of claim 15 wherein said at least one billboard extends outwardly from said shelf providing a display area.

17. The product identifier system of claim 16 wherein said display area contains at least one of the following: indicia identifying contents of products on said shelf and advertising material relating to said products.

18. A product identifier system for identifying each of a plurality of groups of products arrayed on shelves wherein the contents of each of the product groups differ but said groups have like product containers and similar labels, said system including a plurality of billboards, there being at least one of said billboards for each of said groups, each one of said billboards bearing indicia identifying the contents of only one of said groups of products, at least two of said billboards being disposed in horizontally disposed spaced apart relationship, a first of said groups of products being disposed between and bordered by said two of said billboards, a second of said groups of products being separated from said first of said groups by said other of said billboards, the indicia of said one of said billboards identifying the contents of the first of said groups, the indicia of said other of said billboards identifying the contents of the second of said groups.

19. The product identifier system of claim 18 wherein said billboard is disposed in relation to said shelves through contacting engagement with a base clip contactingly engaging a c-channel of said shelf and a connector portion, wherein a lower aperture of said billboard is disposed between a first tab of said base clip and a first aperture of said connector and an upper channel having an arcuate shape is disposed between a second tab of said base clip and a second aperture of said connector.

20. The product identifier system of claim 19 wherein said billboard is rotationally adjustable about the lower aperture through the adjustment of the said second tab engagement with said second aperture within the upper channel.
